(19) United States
(12) Patent Application Publication
(10) Pub. No.: US 2026/0195455 A1
(43) Pub. Date: Jul. 9, 2026

(54) RANSOMWARE RECOVERY AND PREVENTION USING DECENTRALIZED STORAGE PROTOCOL

(71) Applicant: Mysten Labs, Inc., Palo Alto, CA (US)

(72) Inventor: Adrian Perrig, Zurich (CH)

(73) Assignee: Mysten Labs, Inc., Palo Alto, CA (US)

(21) Appl. No.: 19/012,163

(22) Filed: Jan. 7, 2025

(51) Int. Cl. G06F 21/56; G06F 21/78

(52) U.S. Cl. CPC G06F 21/568; G06F 21/565; G06F 21/78

(57) ABSTRACT

This present technology provides a decentralized storage service to offer a BLOB backup service resilient to Ransomware attacks. Even if attackers gain access to the storage system or individual nodes, the Ransomware attempt will fail. Utilizing smart contracts, the system ensures BLOBs are immutable for a specified time, stored in a “write once, read many” (WORM) format, preventing unauthorized modifications. Third-party verifiers can validate data integrity, providing assurance of accurate data storage. Erasure coding techniques allow the recovery of compromised BLOB portions, distributing data across multiple nodes for added resilience. This approach effectively mitigates threats at both the network and individual node levels.

### BACKGROUND

Ransomware is a type of malicious software designed to block access to a computer system or data, typically by encrypting it, until a sum of money—ransom—is paid. These attacks are a significant risk because they can disrupt operations, lead to data loss, and result in financial losses due to the ransom demands and recovery efforts. Beyond immediate financial implications, Ransomware can damage an organization's reputation and lead to the exposure of sensitive information. Traditional Ransomware attacks operate quickly, infiltrating a system and encrypting data en masse. However, some Ransomware variants are designed to progress slowly, encrypting files incrementally. This method allows the malware to evade detection as it gradually compromises files one by one, making it difficult for system administrators to notice the attack until substantial damage has occurred. This stealthy approach reduces the likelihood of early discovery and intervention, giving the attacker more time to demand a ransom without interference.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1A and FIG. 1B illustrate aspects of an erasure coding algorithm for use with a decentralized storage service in accordance with some embodiments of the present technology.

FIG. 2 illustrates an example in which two storage nodes assist another storage node in recovering its erasure-coded sliver pair in accordance with some embodiments of the present technology.

FIG. 3 illustrates a decentralized storage service in accordance with some embodiments of the present technology.

FIG. 4 illustrates an example method for providing data integrity in a decentralized storage service in accordance with some embodiments of the present technology.

FIG. 5 illustrates an example method for using a smart contract to prevent changes to data making up the BLOB in accordance with some embodiments of the present technology.

FIG. 6 illustrates an example method for verifying that BLOB is correctly stored in accordance with some embodiments of the present technology.

FIG. 7 illustrates a blockchain transaction process in accordance with some embodiments of the present technology.

FIG. 8 illustrates a blockchain formation in accordance with some embodiments of the present technology.

FIG. 9 illustrates a blockchain in accordance with some embodiments of the present technology.

FIG. 10 shows an example of a system for implementing some embodiments of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Blockchain technology has expanded its applicability beyond cryptocurrency, providing innovative solutions for decentralized file storage. One benefit of using a blockchain for file storage is to prove data provenance. A file can be stored with metadata attributing the authorship of the file and the blockchain can be used to track subsequent access, versions, and manipulation of a file. Herein a file can be referred to as a binary large object (BLOB), which can represent any data object.

Additionally, blockchains can improve on traditional file storage systems that rely on centralized servers, which can be vulnerable to failures, security breaches, and censorship. In contrast, blockchain-based file storage employs a decentralized network that distributes data across multiple storage nodes, thereby enhancing security, redundancy, and accessibility. Key features of this approach include decentralization, which mitigates single points of failure; immutability and security, which ensure data integrity by making data alterations challenging once stored on the blockchain.

WALRUS, FILECOIN and ARWEAVE serve as examples of blockchain-based storage solutions. WALRUS and FILECOIN operate decentralized networks for storing and retrieving files, offering economic incentives to users contributing unused disk space. They enhance security and redundancy by dividing BLOBs into smaller, encrypted pieces distributed across the network. ARWEAVE, on the other hand, provides a permanent storage solution known as the “permaweb,” designed for indefinite data storage. It utilizes a “Proof of Access” mechanism, requiring miners to verify older data blocks to ensure data durability. ARWEAVE aims to offer a cost-effective method for long-term storage of substantial data volumes.

However, even current blockchain-based storage solutions are vulnerable to manipulation by anyone who appears to have proper access to files. Ransomware attacks are brought by those that have gained access to the storage system. Therefore, although blockchain-based storage systems have additional infrastructure that makes Ransomware attacks more difficult, such systems are still vulnerable to Ransomware attacks.

The present technology builds off of existing blockchain-based storage systems to provide a BLOB backup service that is resilient to Ransomware attacks such that even if an attacker gains access to the storage system or an individual storage node of the network, the Ransomware attack will not be successful. Thus, the backup service can be particularly useful to recover BLOBs that might be corrupted by a Ransomware attack at a primary content management location.

For example, the present technology can make use of smart contracts to restrict the BLOBs from being modified for a period of time. The smart contracts can be used to cause the present technology to store BLOBs in a write once, read many (WORM) that makes the contents of the BLOB immutable−at least for a term specified in the smart contract. In this way, an authorized user or an attacker that has improperly obtained valid credentials cannot modify the BLOB since a network of decentralized storage nodes that maintains the BLOBs would not permit re-writing of the BLOBs per the terms of the smart contract. In this way, the present technology can prevent a Ransomware attack.

In some embodiments, the present technology can also be used to validate that the BLOBs are properly stored. Verifiers that are independent or separate from the network of decentralized separate nodes can utilize one or more techniques to validate that the data stored by the network of decentralized storage nodes is correct. This provides several advantages including providing assurance to the BLOB owner that their data is accurately backed up. And this also provides assurance that even if any specific storage nodes in the network of decentralized storage nodes become controlled by a threat actor, the present technology will be able to notice that a small portion of the BLOB has been compromised. The network can recover any potentially lost portions of BLOBs using erasure coding techniques that distribute portions of BLOBs across multiple storage nodes for resiliency and store the recovered portions on other storage nodes in the network of decentralized storage nodes.

Thus, the present technology thwarts a threat actor at the network level and at the individual storage node level of the system.

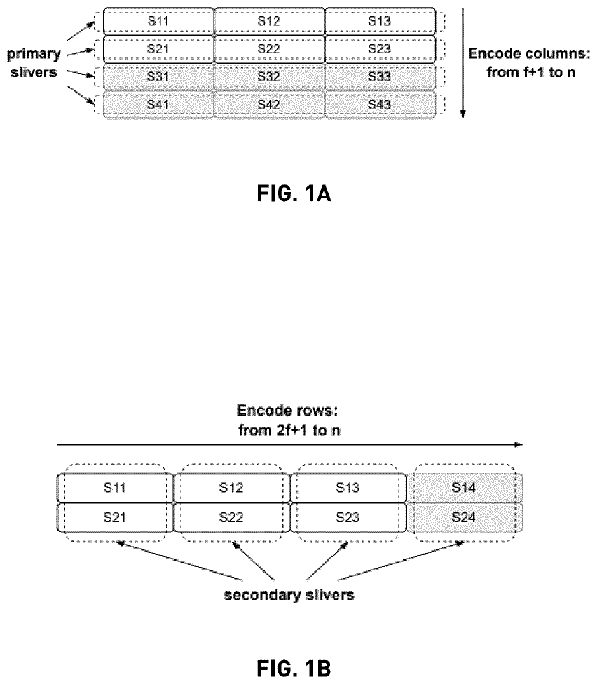

FIG. 1A and FIG. 1B illustrate aspects of an erasure coding algorithm for use with a decentralized storage service in accordance with some embodiments of the present technology.

Erasure coding is a data protection algorithm used to enhance the reliability and storage efficiency of data across distributed systems. It works by breaking data into smaller fragments and encoding it with redundant pieces, allowing the original data to be reconstructed even if some fragments are lost or corrupted. Erasure coding is commonly used in storage systems to improve fault tolerance and reduce storage overhead compared to traditional replication methods. It provides a trade-off between storage efficiency, data recovery speed, and computational complexity, making it a crucial component in modern distributed storage infrastructures.

Reed-Solomon (RS) encoding is a type of erasure coding that provides robust error correction by encoding a block of data into a larger block with additional redundancy. It operates over a finite field and is widely used due to its ability to correct multiple errors and erasures in data. RS encoding involves representing the original data as a polynomial, which is then evaluated at various points to generate code symbols. For instance, if there are \(k\) data symbols, RS encoding generates \(n\) code symbols with \(n>k\). The difference \(n−k\) represents the number of redundant symbols added. The encoded data can then tolerate up to \ (n−k\) erasures or \(\frac{n−k}{2}\) errors, making it highly effective in environments where data integrity is crucial. RS encoding's ability to correct errors significantly contributes to reliable data storage and transmission.

The present technology utilizes an erasure coding algorithm is designed to provide a low overhead factor while maintaining high reliability, making it suitable for long-term deployments. The erasure coding algorithm of the present technology is similar to RS encoding but has been adapted to a storage system that makes use of decentralized storage nodes in a permisionless system. In large-scale systems that operate continuously, storage nodes may encounter failures, lose their assigned erasure-coded slivers, or require replacement. Additionally, in permissionless systems, a natural turnover of storage nodes can occur, even when incentives are in place to encourage their participation.

To address these challenges, the erasure coding algorithm minimizes the cost of data recovery during storage node turnover. Specifically, the recovery cost is proportional only to the amount of data requiring reconstruction and scales inversely with the number of erasure-coded slivers constituting a binary large object (BLOB). To achieve these efficiencies, the protocol employs two-dimensional encoding (2D-encoding). In the first dimension, the BLOB is encoded using a method similar to Reed-Solomon encoding. For improved recovery efficiency, the BLOB is further encoded in a second dimension.

As illustrated in FIG. 1A, the file is divided into 2f+1 columns and f+1 rows. Each column undergoes primary encoding as a separate BLOB, extended with 2f repair symbols. The extended rows resulting from this process are referred to as primary slivers, which are assigned to respective storage nodes.

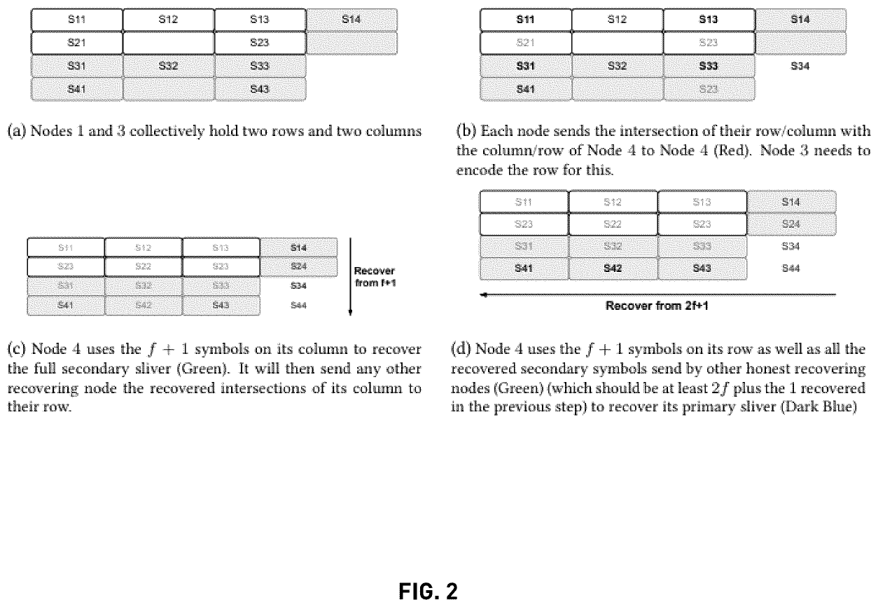

FIG. 1B demonstrates the secondary encoding process. In this step, the file is again divided into 2f+1 columns and f+1 rows. Each row undergoes secondary encoding as a separate BLOB, extended with f repair symbols. The resulting extended columns are designated as secondary slivers, each assigned to a respective storage node. Additionally, the BLOB undergoes an initial splitting into f+1 primary slivers (as depicted in FIGS. 1B) and 2f+1 secondary slivers, forming an [f+1, 2f+1] matrix of symbols. Repair symbols are generated in both dimensions to ensure data integrity.

In the primary encoding phase (illustrated in FIG. 1A), the 2f+1 columns, each consisting of f+1 rows, are extended to n symbols to create n rows. Each of these rows is assigned as a primary erasure-coded sliver and the primary erasure-coded slivers are assigned to a storage node. To enable efficient data recovery, the matrix is further processed in the secondary encoding phase (illustrated in FIG. 1B), where each of the f+1 rows is extended from 2f+1 to n symbols. These n columns are assigned as secondary erasure-coded slivers, which are assigned to respective storage nodes.

To ensure data consistency, a commitment is computed for each erasure-coded sliver. For primary slivers, the commitment covers all symbols in the extended row, while for secondary slivers, the commitment covers all symbols in the extended column. A final commitment, referred to as the BLOB commitment, is generated from the individual sliver commitments, providing an integrity check for the encoded data.

When writing a BLOB, the publisher first encodes the BLOBs and creates an erasure-coded sliver pair for each storage node. An erasure-coded sliver pair i is the pair of i^{th} primary and secondary erasure-coded slivers. There are n=3f+1 erasure-coded sliver pairs for as many as storage nodes. Then, the publisher sends all erasure-coded sliver commitments to every storage node, along with their respective erasure-coded sliver pair. The storage nodes check their own erasure-coded sliver in the pair against the commitments, re-computes the BLOB commitment, and replies with a signed acknowledgment. When 2f+1 signatures are collected, the publisher generates a certificate and posts it on the blockchain to certify the BLOB will be available.

When reading a BLOB, the reader first requests the sets of commitments for the BLOB commitment sought from any storage node, and checks that the returned set corresponds to the BLOB commitment through the commitment open protocol. Then, the reader requests a read for the BLOB commitment from all storage nodes, and they respond with the primary erasure-coded slivers they hold (this may happen gradually to save on bandwidth). Each response is checked against the corresponding commitments in the commitment set for the BLOB. When f+1 correct primary erasure-coded slivers are collected the reader decodes the BLOB and then re-encodes and re-computes the BLOB commitment to check it against the BLOB commitment sought. If it is the same that the publisher posted on chain then the reader outputs the BLOB, otherwise it outputs an error.

FIG. 2 illustrates an example in which two storage nodes, storage nodes 1 and 3 assist another storage node, storage node 4, in recovering its erasure-coded sliver pair in accordance with some embodiments of the present technology.

The present erasure coding algorithm offers significant advantages over traditional Reed-Solomon (RS) coding protocols, particularly in scenarios where storage nodes that did not initially receive their erasure-coded slivers directly from the publisher must recover their slivers. A storage node can recover its secondary erasure-coded sliver by requesting symbols from f+1 other storage nodes. These symbols exist in the row of the requesting storage node and also correspond to the column of the storage nodes providing the symbols, as illustrated in FIG. 2(b) and (c). As a result, all 2f+1 honest storage nodes can eventually possess their secondary erasure-coded slivers.

Once the secondary erasure-coded slivers are recovered, any storage node can then recover its primary erasure-coded sliver. This is achieved by requesting symbols from 2f+1 honest storage nodes for their respective columns, which also correspond to the expanded row of the requesting storage node (FIG. 2(d)). During this process, each responding storage node transmits the requested symbols along with their corresponding openings from the commitment of the source erasure-coded sliver. These commitments allow the requesting storage node to verify the integrity of the received symbols, ensuring that they match the original data encoded by the publisher if the publisher was honest. This mechanism guarantees accurate decoding.

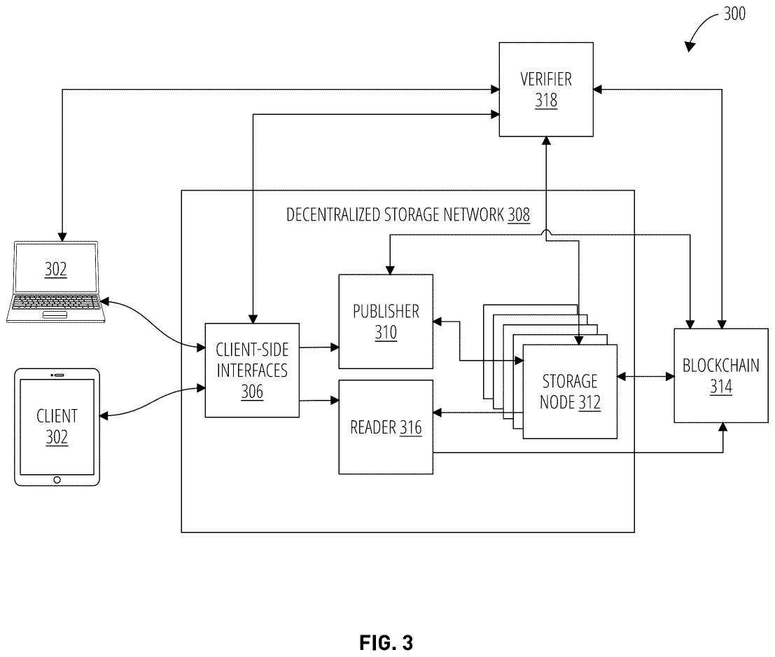

The protocol achieves scalability by maintaining low communication complexity. Specifically, each symbol has a size proportional to O(B/n²), where B is the size of the original data and n is the total number storage nodes. Since each storage node downloads O(n) total symbols, the cost storage node is O(B/n), and the total communication cost for recovering the file remains O(B). This is equivalent to the cost of performing a read or write operation. As a result, the communication complexity of the protocol is nearly independent of n, allowing for efficient and scalable operation in large systems. FIG. 3 illustrates a decentralized storage service in accordance with some

embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

The system integrates clients 302, decentralized storage network 308, blockchain 314, and verifier 318 to enable secure and efficient storage and retrieval of binary large objects (BLOBs). Clients 302 can interact with the system through client-side interfaces 306 that provide access to the decentralized storage network 308. These interfaces enable users to perform operations such as uploading BLOBs for storage, requesting stored data, and managing metadata associated with the BLOBs. While the clients 302 are depicted as personal computing devices, the client 302 can be a storage service, administrator device, end user device, etc. In some embodiments, the clients 302 can be controlled by data owners wishing to store, validate, or retrieve their data on the decentralized storage service 300. In some embodiments, the clients 302 can be controlled by a party other than the data owner that is authorized to read or validate the data owner's data on decentralized storage service 300.

The decentralized storage service 300 can be used to storage any data and can be used as a primary storage solution or as a backup storage solution. However, the present technology emphasizes the benefits of the decentralized storage service 300 for its benefits as a backup storage solution where the data is primarily stored in a primary storage solution. In this environment, the primary storage solution can provide access to files that can be read or written (or re-written with new versions). The primary storage solution can be a client 302 of the decentralized storage service 300 such that the primary storage solution can send some or all of its data to be backed up by decentralized storage service 300. Depending on the objectives of using the decentralized storage service 300 as a backup solution, the client 302 might store all of its data on decentralized storage service 300 for 3-mo intervals, 6-mo intervals, or persistently. In another use case, the decentralized storage service 300 might store backups of data requiring a very high quality of service and store such data for a long interval.

An advantage of using decentralized storage service 300 as a backup storage solution is that if the primary storage solution is subject to a Ransomware attack, the backup storage solution will be unaffected and all of the data in the primary storage solution can be promptly recovered from decentralized storage service 300. Decentralized storage service 300 can store data as write once, read many (WORM) storage. WORM storage allows for a data object (BLOB) to be accessed for reading, but the BLOB cannot be overwritten.

One way that Ransomware is often affected is that once an attacker gains access to a storage system, they can often find the encryption keys so they can not only re-encode the data, but they can read it too. But when using decentralized storage service 300, which is an independent system, additional encryption keys are used. Even if the encryption keys from the primary storage system are stolen, each node of the decentralized storage nodes can use their own encryption keys to protect the segments (slivers) of data they store. And since the data is stored as WORM, a threat actor cannot overwrite the data.

The decentralized storage service 300 integrates a blockchain 314 as a control plane for metadata and governance with an erasure coding algorithm executed by a committee of storage nodes 312 to handle binary large object (BLOB) contents. An example of the decentralized storage service 300 is WALRUS by MYSTEN LABS, and an example of the blockchain 314 is the SUI blockchain created by MYSTEN LABS. However, the decentralized storage service 300 can be generalized to support any blockchain and encoding/decoding/erasure encoding algorithm that meets the minimal requirements.

For operational simplicity, the publisher 310 may assume that each storage node operates as a virtual storage node managing a single shard, while a physical storage node may control multiple virtual storage nodes with distinct virtual identities. The operations of the decentralized storage service 300 during an epoch primarily include: (a) writing a BLOB and (b) reading a BLOB.

The publisher 310 depicted in FIG. 3 is responsible for receiving BLOBs from clients 302, dividing the BLOBs into smaller data units called slivers, and encoding these slivers using an erasure coding algorithm. The erasure coding algorithm generates erasure-coded slivers that are resilient to data loss or corruption. The publisher 310 further generates metadata for the BLOB, including a BLOB ID derived by hashing the BLOB commitment along with other metadata, such as the size of the BLOB and the type of encoding. Once the erasure-coded slivers and associated metadata are prepared, the publisher 310 submits a transaction to the blockchain 314 to register the BLOB and acquire storage space for it across a network of storage nodes 312. This transaction includes the BLOB size and BLOB commitment, which can be used to re-derive the BLOB ID. The blockchain 314 also secures sufficient storage space and governs access policies through smart contracts. These contracts may define conditions under which the BLOB can be accessed and ensure compliance by the storage nodes 312.

After the transaction is committed, the publisher 310 distributes the erasure-coded slivers, along with proofs of consistency, to the storage nodes. Each storage node 312 verifies the received data and replies with a signed acknowledgment once the data has been stored. When the publisher 310 collects signed acknowledgments from at least 2f+12f+1 storage nodes, it generates a write certificate that is published on the blockchain 314. This write certificate marks the Point of Availability (PoA) for the BLOB, signaling the obligation of the storage nodes to maintain the availability of the erasure-coded slivers for a specified duration. At this stage, the publisher 310 may delete the BLOB from its local storage and go offline. The PoA also serves as proof of the BLOB's availability for use by third parties or integration with smart contracts.

In greater detail, the process of writing a BLOB begins with the publisher 310 encoding the BLOB using an erasure coding algorithm. This process generates erasure-coded sliver pairs, a list of commitments to the slivers, and a BLOB commitment. The publisher 310 derives a BLOB ID by hashing the BLOB commitment along with metadata, such as the BLOB length and encoding type. The publisher 310 submits a transaction to the blockchain 314 to acquire sufficient storage space for the BLOB during a sequence of epochs and to register the BLOB. The transaction includes the BLOB size and BLOB commitment, which can be used to re-derive the BLOB ID. The blockchain smart contract ensures sufficient storage space for both the erasure-coded slivers on the nodes and the metadata associated with the commitments. Payment may be included in the transaction to secure storage space.

Once the transaction is committed, the publisher 310 informs the storage nodes 312 of their obligation to store the erasure-coded slivers corresponding to the BLOB ID. This notification includes the transaction, the commitments, the assigned primary and secondary erasure-coded slivers, and proofs of consistency with the BLOB ID. Each storage node verifies the commitments and responds with a signed acknowledgment after storing the assigned data. Upon receiving acknowledgments from at least 2f+12f+1 nodes, the publisher 310 generates a write certificate and provides it to the client 302. The certificate is then published on the blockchain 314, marking the Point of Availability (PoA) for the BLOB. The PoA indicates the storage nodes'obligation to maintain the erasure-coded slivers for the specified epochs. At this stage, the publisher 310 can delete the BLOB from local storage and go offline. The PoA also serves as proof of the BLOB's availability for third-party users and smart contracts. Storage nodes 312 monitor the blockchain for PoA events. If a storage node does not already hold the erasure-coded slivers for a BLOB, it executes a recovery process to retrieve the necessary

commitments and sliver data, ensuring that all correct nodes eventually hold the complete set of erasure-coded slivers for the BLOB.

To retrieve a BLOB, a reader 316 initiates a request through the client-side interfaces to the decentralized storage network 308. The reader queries storage nodes 312 for the commitments and erasure-coded slivers associated with the BLOB ID. Upon receiving at least f+1f+1 valid replies from the storage nodes 312, the reader 316 reconstructs the BLOB and verifies its integrity by re-computing the BLOB ID. If the recomputed ID matches the original BLOB ID, the reconstructed BLOB is provided to the client 302. If the verification fails, the system returns an error. The erasure coding algorithm ensures consistent and efficient reads, requiring the download of only slightly more data than the original BLOB size under normal operating conditions.

In a best-effort read path, a reader 316 requests commitments and primary erasure-coded slivers for a BLOB by its ID from storage nodes 312. Once the reader collects at least f+1f+1 valid replies, it reconstructs the BLOB, re-encodes it, and recomputes the BLOB ID. If the recomputed ID matches the original BLOB ID, the reader outputs the BLOB. Otherwise, an error is returned, indicating inconsistency. This read process benefits from the properties of the erasure coding algorithm, allowing retrieval of data with minimal overhead, even in the presence of failures.

The decentralized storage service 300 also includes mechanisms for ensuring data integrity and availability. A verifier 318 periodically checks the correctness of stored erasure-coded slivers using cryptographic proofs, which are reported to the blockchain 314. The verifier can be an independent system of a data owner that would not be compromised if the data owner's primary storage solution were attacked or a third party verifier under the control of the data owner. If a storage node 312 is found to be noncompliant or if data corruption is detected, the system initiates a recovery process. During this process, missing or corrupted slivers are reconstructed and redistributed to maintain the integrity and availability of the BLOB. The verifier ensures that even in asynchronous networks or under conditions where nodes experience failures, all honest storage nodes can recover their assigned data.

In asynchronous networks or when nodes experience crash-recover events, not all nodes may receive their erasure-coded slivers during the initial write operation. The present technology addresses this by employing a two-dimensional encoding scheme that ensures completeness. Completeness enables every honest storage node to recover and eventually hold an erasure-coded sliver for every BLOB past its PoA. This provides several benefits, including: (1) improved load balancing of read requests, as all nodes can respond to readers; 2) dynamic availability of storage nodes, enabling reconfiguration without reconstructing and rewriting every BLOB; and 3) support for a fully asynchronous protocol for verifying stored data.

The recovery process allows a storage node that lacks a sliver to retrieve it by requesting symbols from other nodes. A recovering storage node identifies the intersection of its primary or secondary erasure-coded slivers with the slivers held by other nodes. Since 2f+1 2f+1 nodes sign the certificate, at least f+1f+1 will be honest and respond. This ensures that all 2f+12f+1 honest nodes eventually hold both primary and secondary erasure-coded slivers. The ability of nodes to recover their slivers ensures efficient operation and data availability throughout the system.

The decentralized storage service 300 illustrated in FIG. 3 provides several advantages. By leveraging a blockchain-based control plane for metadata and governance, it ensures secure and verifiable storage operations. The use of erasure coding algorithm enhances data resilience while maintaining scalability by minimizing communication complexity. Additionally, the system enforces strict access controls through smart contracts, ensuring that only authorized parties can access the stored data. These features collectively enable the system to provide a robust and efficient framework for decentralized storage and retrieval of data.

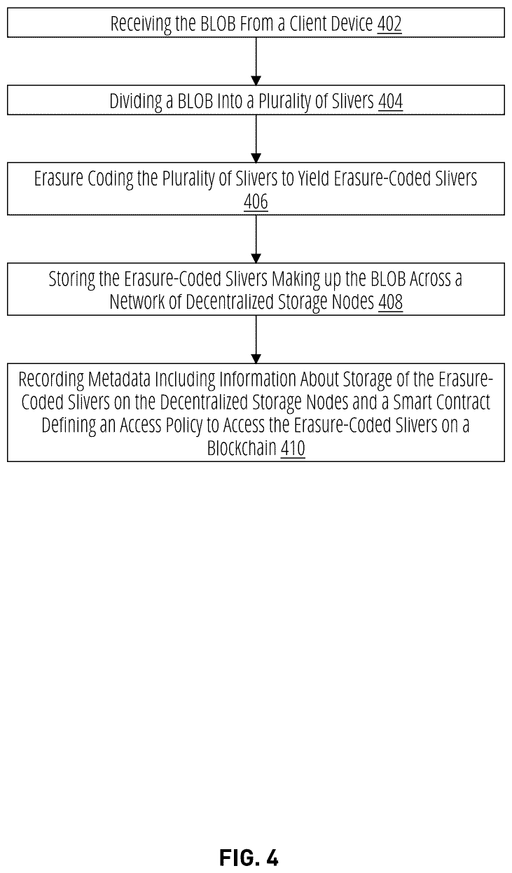

FIG. 4 illustrates an example method for providing data integrity in a decentralized storage service in accordance with some embodiments of the present technology. Although the example method depicts a particular sequence of operations, the sequence may be altered without departing from the scope of the present disclosure. For example, some of the operations depicted may be performed in parallel or in a different sequence that does not materially affect the function of the method. In other examples, different components of an example device or system that implements the method may perform functions at substantially the same time or in a specific sequence.

According to some examples, the method includes receiving the BLOB from a client device at block 402. For example, the publisher 310 illustrated in FIG. 3 may receive the BLOB from a client device. The BLOB is to be stored by the network of decentralized storage nodes.

In some embodiments, the BLOB can have been encrypted by the client device prior to sending it to the publisher 310. While the BLOB is encoded by the erasure coding algorithm such that the BLOB is not readable with any one erasure-coded sliver, and while the storage nodes 312 may also encrypt the data they store, some clients prefer the added layer of protection of sending encrypted data to be stored such that no entity in the decentralized storage service 300 can read the contents of the BLOB.

According to some examples, the method includes dividing a BLOB into a plurality of slivers at block 404. For example, the publisher 310 illustrated in FIG. 3 may divide a BLOB into a plurality of slivers as an initial step of the erasure coding algorithm.

According to some examples, the method includes erasure coding the plurality of slivers to yield erasure-coded slivers at block 406. For example, the publisher 310 illustrated in FIG. 3 may erasure code the plurality of slivers to yield erasure-coded slivers. The erasure-coded slivers make the BLOB resilient to data loss or corruption of some of the erasure-coded slivers.

According to some examples, the method includes storing the erasure-coded slivers making up the BLOB across a network of decentralized storage nodes at block 408. For example, the publisher 310 illustrated in FIG. 3 may store the erasure-coded slivers making up the BLOB across a network of decentralized storage nodes. The erasure coding and distributing of the erasure-coded slivers making up the BLOB ensure that the BLOB (and any of the slivers) can be reconstructed even if one or more of the erasure-coded slivers are lost or corrupted.

In some embodiments, the decentralized storage nodes are governed by a consensus protocol shared amongst the decentralized storage nodes. The consensus protocol has attributes that the decentralized storage nodes will accurately and verifiably store the erasure-coded slivers, that access to the erasure-coded slivers is subject to one or more policies defined by a smart contract or the consensus protocol, and the failure to comply with the consensus protocol results in removal from the network of decentralized storage nodes.

According to some examples, the method includes recording metadata including information about storage of the erasure-coded slivers on the decentralized storage nodes and a smart contract defining an access policy to access the erasure-coded slivers on a blockchain at block 410. For example, the publisher 310 illustrated in FIG. 3 may record metadata, including information about the storage of the erasure-coded slivers on the decentralized storage nodes and a smart contract defining an access policy to access the erasure-coded slivers on a blockchain. The metadata includes erasure-coded sliver locations. The metadata can also encryption keys for the erasure-coded slivers stored across the decentralized storage nodes. The metadata includes information that can be used to verify that the erasure-coded slivers are stored correctly, such as cryptographic proofs that can be used to verify that the erasure-coded slivers are stored correctly by the decentralized storage nodes.

In some embodiments, the cryptographic proofs are provided by the verifier, and reported to the blockchain over a channel that is independent of the network of decentralized storage nodes. The verifier can be an independent system of the data owner or a third party verifier under the control of the data owner.

In some embodiments, the smart contract prohibits re-writing of the BLOB or the erasure-coded slivers making up the BLOB for a period. A smart contract with terms that prohibit rewriting the BLOB can be especially useful when the user is utilizing the decentralized storage service 300 as a data backup or recovery service.

A smart contract that prohibits modifications or deletions of a BLOB can cause the storage nodes to refuse to accept any change to the erasure-coded slivers making up the BLOB during the period specified in the smart contract. As will be addressed further below, this is one mechanism by which the present technology can ensure that a threat actor cannot affect a ransomware attack.

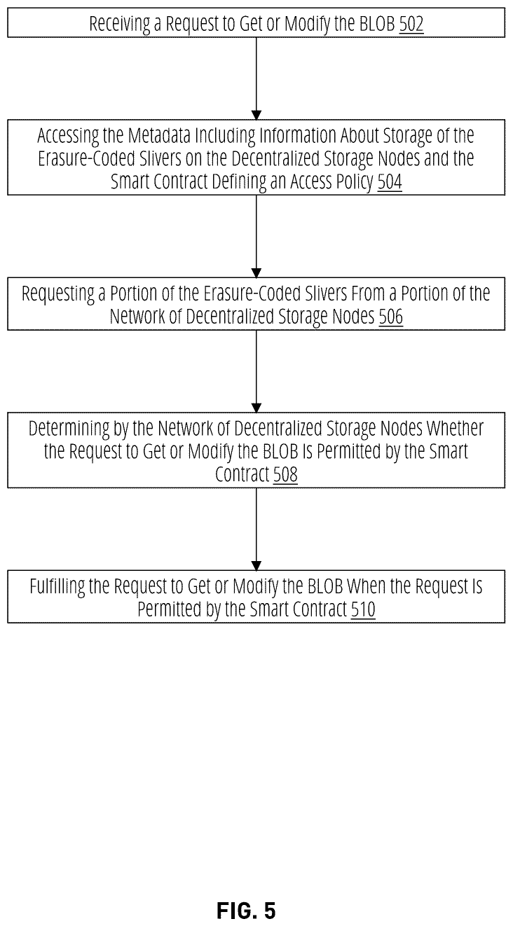

FIG. 5 illustrates an example method for using a smart contract to prevent changes to data making up the BLOB in accordance with some embodiments of the present technology. Although the example method depicts a particular sequence of operations, the sequence may be altered without departing from the scope of the present disclosure. For example, some of the operations depicted may be performed in parallel or in a different sequence that does not materially affect the function of the method. In other examples, different components of an example device or system that implements the method may perform functions at substantially the same time or in a specific sequence.

According to some examples, the method includes receiving a request to get or modify the BLOB at block 502. For example, the reader 316 illustrated in FIG. 3 may receive a request to get or modify the BLOB.

According to some examples, the method includes accessing, from the blockchain, the metadata including information about storage of the erasure-coded slivers on the decentralized storage nodes and the smart contract defining an access policy at block 504. For example, the reader 316 illustrated in FIG. 3 may access the metadata including information about storage of the erasure-coded slivers on the decentralized storage nodes and the smart contract defining an access policy. As addressed above, a certificate associated with a BLOB id can be stored on the blockchain 314. The certificate can include the Point of Availability (PoA) for the BLOB which can indicate which storage nodes store erasure-coded slivers making up the BLOB and the certificate can also include or reference the smart contract, which defines the storage nodes 312 obligation to store the erasure-coded slivers for a period of time, and can define whether the erasure-coded slivers should be accessible for reading and/or writing.

According to some examples, the method includes requesting a portion of the erasure-coded slivers from a portion of the network of decentralized storage nodes at block 506. For example, the reader 316 illustrated in FIG. 3 may request a portion of the erasure-coded slivers from a portion of the network of decentralized storage nodes. In particular, the reader 316 can request erasure-coded slivers making up the BLOB from the storage nodes 312 identified on the blockchain 314 in association with the BLOB id.

According to some examples, the method includes determining by the network of decentralized storage nodes whether the request to get or modify the BLOB is permitted by the smart contract at block 508. For example, the storage node 312 illustrated in FIG. 3 may determine by the network of decentralized storage nodes whether the request to get or modify the BLOB is permitted by the smart contract. Simply, if the request to get (read) or modify (write) the BLOB and its associated erasure-coded slivers is not permitted by the smart contract, the network of decentralized storage nodes will not permit the action.

Again, the smart contract can prevent a ransomware attack even if the threat actor has somehow received access to the system or even the decryption keys because the data associated with the smart contract is immutable for the period specified by the smart contract.

According to some examples, the method includes fulfilling the request to get or modify the BLOB when the request is permitted by the smart contract at block 510. For example, the storage node 312 illustrated in FIG. 3 may fulfill the request to get or modify the BLOB when the request is permitted by the smart contract.

In the case of using decentralized storage service as a backup service, the client 302 can receive the BLOB stored by the decentralized storage service in the event that a primary storage of the data is compromised.

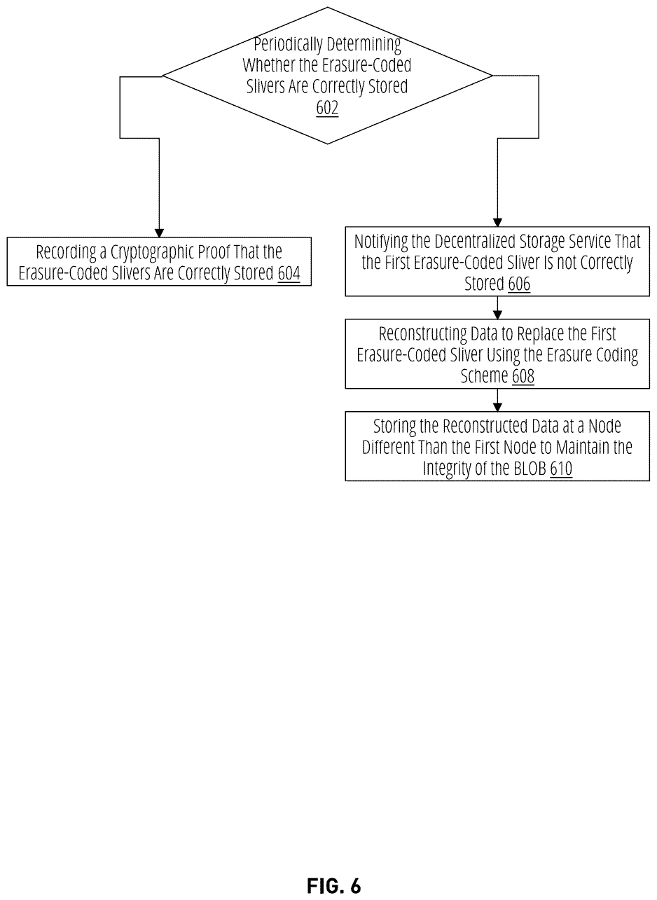

FIG. 6 illustrates an example method for verifying that a BLOB is correctly stored in accordance with some embodiments of the present technology. Although the example method depicts a particular sequence of operations, the sequence may be altered without departing from the scope of the present disclosure. For example, some of the operations depicted may be performed in parallel or in a different sequence that does not materially affect the function of the method. In other examples, different components of an example device or system that implements the method may perform functions at substantially the same time or in a specific sequence.

While the methods illustrated in FIG. 4 and FIG. 5 pertain to storing and retrieving a BLOB from the decentralized storage service, and demonstrate that the decentralized storage service can be used to protect data from being changed or modified unless permitted by terms in a smart contract, FIG. 6 pertains to a method for verification that the BLOB is properly stored by the decentralized storage service. Accordingly, FIG. 4 and FIG. 5 pertain to the function of the decentralized storage service as a whole to be resilient to attacks that attempt to modify data stored by the decentralized storage service, FIG. 6 validates that no individual node has been corrupted.

This method can be useful for providing confidence in the validity of the decentralized storage service 300 and for being an early warning system to catch when a Ransomware attack is attempted.

According to some examples, the method includes periodically determining whether the erasure-coded slivers are correctly stored at decision block 602. For example, the verifier 318 illustrated in FIG. 3 may periodically determine whether the erasure-coded slivers are correctly stored. Since the method is periodically performed, the data in decentralized storage service 300 is repeatedly being checked for problems. Thus, if a storage node 312 experiences the start of a Ransomware attack, which will require the attacker to control the entire node such that the node no longer respects the smart contract on the blockchain, the system will detect that the data on that storage node 312 is invalid.

In some embodiments, the determining whether the erasure-coded slivers are correctly stored can be performed on encrypted data even without the encryption key using a root hash value. For example, the verifier 318 can create a cryptographic hash of erasure-coded slivers and compare the cryptographic hash to a reference value stored at the blockchain. If the reference values match, the erasure-coded sliver is valid, but if the reference values do not match, then the erasure-coded sliver has been modified. The calculation of the hash of the erasure-coded slivers does not require decrypting the erasure-coded sliver.

In some embodiments, the determining whether the erasure-coded slivers are correctly stored can be performed using dummy files, known only to the system, to verify backup integrity without exposing the actual data. In these examples, the verifier 318 can request and receive a dummy BLOB that is stored amongst valid BLOBs such that the dummy BLOB is indistinguishable from a valid BLOB to a threat actor. The data owner backing up their data using decentralized storage service 300 can provide decryption keys for only the dummy BLOB to the verifier. The verifier 318 can verify that the dummy BLOB is retrievable and decryptable as an indirect measure of overall data integrity. If the verifier 318 cannot retrieve and decrypt the dummy file, this suggests that other valid BLOBs might also be compromised, and the verifier 318 can inform the data owner of the problem and cause the network of decentralized storage nodes to recover the corrupted data from other valid erasure-coded slivers.

According to some examples, when a first erasure-coded sliver at a first storage node of the erasure-coded slivers stored by the network of decentralized storage nodes is not correctly stored, the method includes notifying the data owner that the first erasure-coded sliver is not correctly stored at block 606. For example, the verifier 318 illustrated in FIG. 3 may notify the data owner that the first erasure-coded sliver is not correctly stored. At this point thedata owner can request the decentralized storage service 300 toreconstruct the data (block 608) on a healthy node.

According to some examples, the method includes reconstructing data to replace the first erasure-coded sliver using the erasure coding algorithm at block 608. For example, the storage node 312 illustrated in FIG. 3 may reconstructing data to replace the first erasure-coded sliver using the erasure coding algorithm.

According to some examples, the method includes storing the reconstructed data at a storage node different than the first storage node to maintain the integrity of the BLOB at block 610. For example, the storage node 312 illustrated in FIG. 3 may store the reconstructed data at a storage node different than the first storage node to maintain the integrity of the BLOB.

In the described system, upon detection of an attack on certain storage nodes resulting in information deletion, the system initiates a process to regenerate the affected information. This information is subsequently redistributed to other operational storage nodes. The system incorporates mechanisms that continuously verify each storage node's claim to store specific data, and these mechanisms also ensure the stored information's integrity and correctness.

According to some examples, when a first erasure-coded sliver at a first storage node of the erasure-coded slivers stored by the network of decentralized storage nodes are correctly stored, the method includes recording a cryptographic proof that the erasure-coded slivers are correctly stored at block 604. For example, the verifier 318 illustrated in FIG. 3 may record a cryptographic proof that the erasure-coded slivers are correctly stored. In this way, the verifier 318 can provide trust to the client 302 and to the network at large that the network is functioning properly.

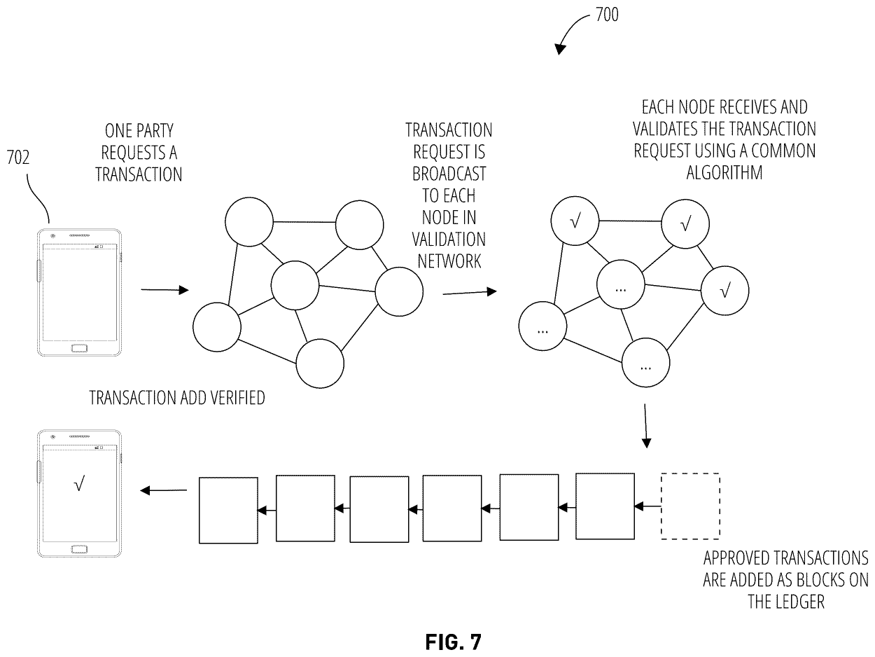

Referring to FIG. 7, a blockchain is an ever-growing set of data blocks. Each block records a collection of transactions. Blockchains distribute these transactions across a group of computers. Each computer maintains its own copy of the blockchain transactions.

A blockchain is a continuously growing list of records, called blocks, which are linked and secured using cryptography. Each block typically comprises a cryptographic hash of the previous block, a timestamp, and transaction data. By design, a blockchain is resistant to modification of the data. Blockchains may implement an open, distributed ledger that can record transactions between two parties efficiently and in a verifiable and permanent way.

A blockchain is typically managed by multiple parties collectively adhering to a protocol for inter-node communication and validating new blocks. Once recorded, the data in any given block cannot be altered retroactively without alteration of all subsequent blocks, which requires consensus among the operators.

Cryptography involving mathematical methods of keeping data secret and proving identity is utilized when recording transactions. One digital key ensures only an owner can enter a transaction to the blockchain involving their assets, and another digital key lets other parties confirm it really was the owner who added the transaction.

Blockchain is resistant to tampering or other changes by utilizing a cryptographic technique called the hash. Hashing reduces data to a sequence of seemingly random characters —For example, the hash of the phrase “the quick brown fox” is “9ECB36561341D18EB65484E833EFEA61EDC74B84CF5E6AE1B81C63533E25FC8F” using a hash method called SHA-256. Tweaking just one letter in the phrase produces a completely different hash, and you can't go backward to figure out the original data from the hash.

With blockchain, hashes are linked together so any minute change is immediately visible, not just for the block housing it but for all other blocks added later. With red flags that big for changes that small, auditing becomes easier.

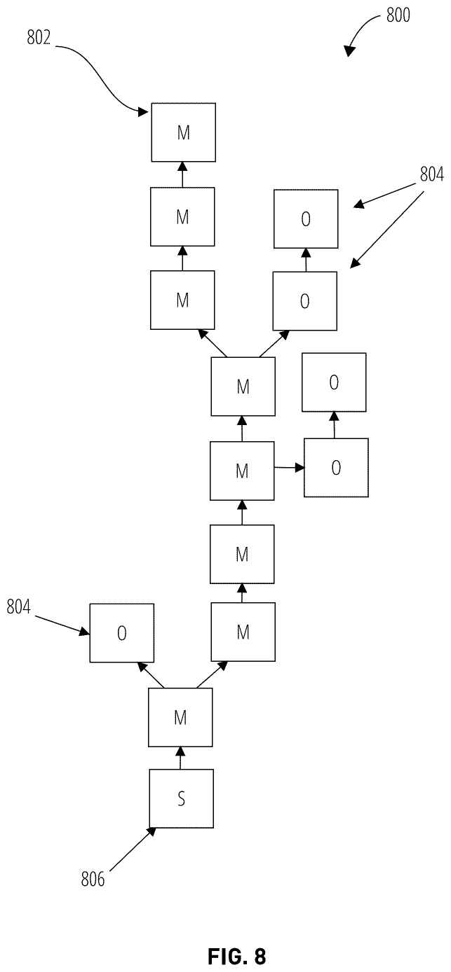

FIG. 8 illustrates an exemplary blockchain formation 800. The mainchain 802 (M blocks) comprises the longest series of blocks from the start block 806 (S block) to the current block. Orphan blocks 804 (O blocks) exist outside of the main chain.

Blocks hold batches of valid transactions that are hashed and encoded, for example into a Merkle tree. Each block includes the cryptographic hash of the prior block in the blockchain formation 800, linking the two. The linked blocks form a chain. This iterative process confirms the integrity of the previous block, all the way back to the original start block 806.

Sometimes separate blocks can be produced concurrently, creating a temporary fork. In addition to a secure hash-based history, the blockchain formation 800 has a specified algorithm for scoring different versions of the history so that one with a higher value can be selected over others. Blocks not selected for inclusion in the mainchain 802 are called orphan blocks 804. Peers supporting the blockchain formation 800 have different versions of the history from time to time. They keep only the highest-scoring version of the blockchain formation 800 known to them. Whenever a peer receives a higher-scoring version (usually the old version with a single new block added) they extend or overwrite their local version of the blockchain formation 800 and retransmit the improvement to their peers. There is never an absolute guarantee that any particular entry will remain in the best version of the history forever. Because blockchains are typically built to add the score of new blocks onto old blocks and because there are incentives to work only on extending with new blocks rather than overwriting old blocks, the probability of an entry becoming superseded goes down exponentially as more blocks are built on top of it, eventually becoming very low. For example, in a blockchain using the proof-of-work system, the chain with the most cumulative proof-of-work is always considered the valid one by the network. There are a number of methods that can be used to demonstrate a sufficient level of computation. Within a blockchain the computation is carried out redundantly rather than in the traditional segregated and parallel manner.

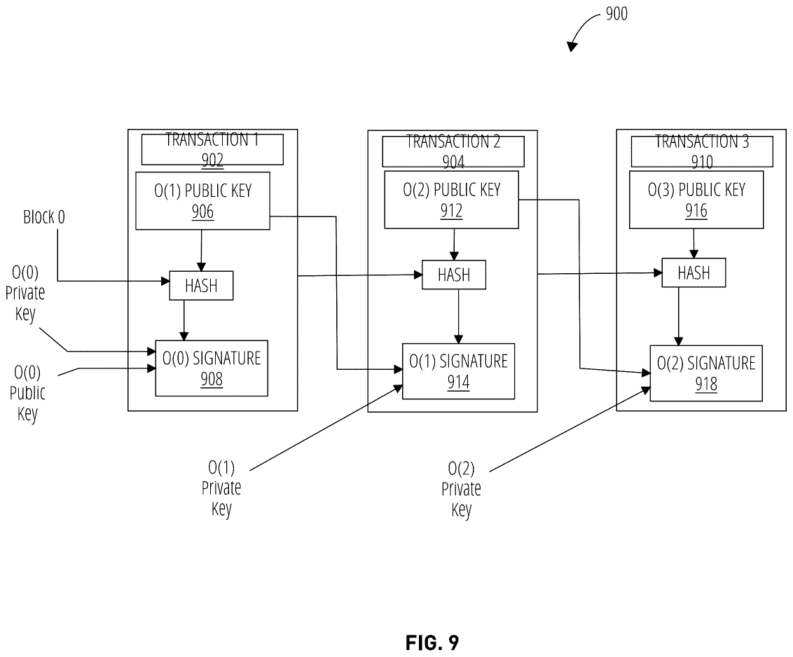

FIG. 9 illustrates an embodiment of an irreversible transaction blockchain 900. The blockchain 900 is a sequence of digitally signed transactions (transaction 1 902, transaction 2 904, and transaction 3 910 etc.). Each transaction includes the current owners public key (block 1 owner public key 906, block 2 owner public key 912, and block 3 owner public key 916 respectively) and the previous owner's signature (O(0) signature 908, O(1) signature 914, and O(2) signature 918) which are generated using a hash function. The owner of a transaction can examine each previous transaction to verify the chain of ownership. Unlike traditional check endorsements, the transactions in the blockchain 900 are irreversible, which mitigates fraud.

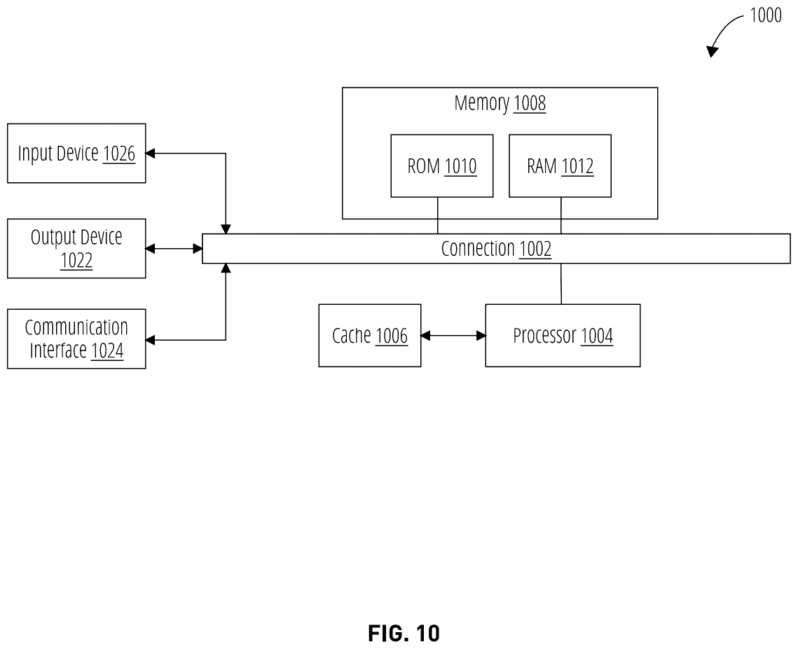

FIG. 10 shows an example of computing system 1000, which can be, For example, any computing device making system decentralized storage service 300 illustrated in FIG. 3 or any component thereof.

In some embodiments, computing system 1000 is a single device, or a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

In some embodiments, computing system 1000 may comprise one or more computing resources provisioned from a “cloud computing” provider, For example, AMAZON ELASTIC COMPUTE CLOUD (“AMAZON EC2”), provided by AMAZON, INC. of Seattle, Washington; SUN CLOUD COMPUTER UTILITY, provided by SUN MICROSYSTEMS, INC. of Santa Clara, California; AZURE, provided by MICROSOFT CORPORATION of Redmond, Washington, GOOGLE CLOUD PLATFORM, provided by ALPHABET, INC. of Mountain View, California, and the like.

Example computing system 1000 includes at least one processing unit (CPU or processor) 1004 and connection 1002 that couples various system components including system memory 1008, such as read-only memory (ROM) 1010 and random access memory (RAM) 1012 to processor 1004. Memory 1008 can be a volatile or non-volatile memory device, and can be a hard disk or other types of non-transitory computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

Memory 1008 can include software services, servers, logic, etc., that when the code that defines such software is executed by the processor 1004, it causes the system to perform a function. In some embodiments, a hardware service that performs a particular function can include the software component stored in a computer-readable medium in connection with the necessary hardware components, such as processor 1004, connection 1002, output device 1022, etc., to carry out the function.

Computing system 1000 can include a cache of high-speed memory 1006 connected directly with, in close proximity to, or integrated as part of processor 1004.

Connection 1002 can be a physical connection via a bus, or a direct connection into processor 1004, such as in a chipset architecture. Connection 1002 can also be a virtual connection, networked connection, or logical connection.

Processor 1004 can include any general purpose processor and a hardware service or software service stored in memory 1008, configured to control processor 1004 as well as a special-purpose processor where software instructions are incorporated into the actual processor design. Processor 1004 may essentially be a completely self-contained computing system, containing multiple cores or processors, a bus, memory controller, cache, etc. A multi-core processor may be symmetric or asymmetric. Processor 1004 can be physcial or virtual.

To enable user interaction, computing system 1000 includes an input device 1026, which can represent any number of input mechanisms, such as a microphone for speech, a touch-sensitive screen for gesture or graphical input, keyboard, mouse, motion input, speech, etc. Computing system 1000 can also include output device 1022, which can be one or more of a number of output mechanisms known to those of skill in the art. In some instances, multimodal systems can enable a user to provide multiple types of input/output to communicate with computing system 1000. Computing system 1000 can include communication interface 1024, which can generally govern and manage the user input and system output. There is no restriction on operating on any particular hardware arrangement, and therefore the basic features here may easily be substituted for improved hardware or firmware arrangements as they are developed.

In some embodiments, computing system 1000 can refer to a combination of a personal computing device interacting with components hosted in a data center, where both the computing device and the components in the data center. In such examples, both the personal computing device and the components in the datacenter might have a processor, cache, memory, storage, etc.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, For example, instructions and data which cause or otherwise configure a general purpose computer, special purpose computer, or special purpose processing device to perform a certain function or group of functions. Portions of computer resources used can be accessible over a network. The computer executable instructions may be, For example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method for providing data integrity in a decentralized storage service, the method comprising:
dividing a BLOB into a plurality of erasure-coded slivers;
erasure coding the plurality of erasure-coded slivers using an erasure coding algorithm to yield erasure-coded slivers, the erasure-coded slivers make the BLOB resilient to data loss or corruption of some of the erasure-coded slivers;
storing the erasure-coded slivers making up the BLOB across a network of decentralized storage nodes, wherein the decentralized storage nodes are governed by a consensus protocol shared amongst the decentralized storage nodes;
recording metadata including information about storage of the erasure-coded slivers on the decentralized storage nodes and a smart contract defining an access policy to access the erasure-coded slivers on a blockchain, wherein the smart contract prohibits, for a period, the re-writing of the BLOB or the erasure-coded slivers making up the BLOB.

2. The method of claim 1, further comprising:
receiving, by the decentralized storage service, the BLOB from a client device, the BLOB to be stored by the network of the decentralized storage nodes, wherein the BLOB has been encrypted by the client device.

3. The method of claim 1, wherein the metadata includes information verifying that the erasure-coded slivers are stored correctly, wherein the information verifying that the erasure-coded slivers are stored correctly includes cryptographic proofs that can be used to verify that the erasure-coded slivers are stored correctly by the decentralized storage nodes.

4. The method of claim 3, wherein the cryptographic proofs are reported to the blockchain over a channel that is independent of the network of the decentralized storage nodes.

5. The method of claim 1, further comprising:
periodically determining, by a verifier, whether the erasure-coded slivers are correctly stored;
when the erasure-coded slivers are correctly stored, recording a cryptographic proof that the erasure-coded slivers are correctly stored.

6. The method of claim 1, further comprising:
periodically determining, by a verifier, whether the erasure-coded slivers are correctly stored;
when a first erasure-coded sliver at a first storage node of the erasure-coded slivers stored by the network of the decentralized storage nodes are not correctly stored, notifying a data owner that the first erasure-coded sliver is not correctly stored;
reconstructing data to replace the first erasure-coded sliver using the erasure coding algorithm;
storing the reconstructed data at a storage node different than the first storage node to maintain the integrity of the BLOB.

7. The method of claim 1, further comprising:
receiving a dummy BLOB to be stored with the BLOB, wherein the dummy BLOB is indistinguishable from the BLOB to a threat actor;
providing decryption keys for only the dummy BLOB to a verification entity; and
verifying that the dummy BLOB is retrievable and decryptable as an indirect measure of overall data integrity.

8. The method of claim 5, wherein the cryptographic proofs are generated by:
using a cryptographic hash of the erasure-coded slivers;
comparing the cryptographic hash to a reference value stored at the blockchain;
ensuring that the erasure-coded slivers are valid without exposing decryption keys.

9. The method of claim 1, further comprising:
receiving a request to get or modify the BLOB;
accessing, from the blockchain, the metadata including information about storage of the erasure-coded slivers on the decentralized storage nodes and the smart contract defining the access policy;
requesting a portion of the erasure-coded slivers from a portion of the network of the decentralized storage nodes;
determining by the network of the decentralized storage nodes whether the request to get or modify the BLOB is permitted by the smart contract; and
fulfilling the request to get or modify the BLOB when the request is permitted by the smart contract.

10. A computing system comprising:
a processor; and
a memory storing instructions that, when executed by the processor, configure the computing system to:
divide a BLOB into a plurality of erasure-coded slivers;
erasure code the plurality of erasure-coded slivers using an erasure coding algorithm to yield erasure-coded slivers, the erasure-coded slivers make the BLOB resilient to data loss or corruption of some of the erasure-coded slivers;
store the erasure-coded slivers making up the BLOB across a network of decentralized storage nodes, wherein the decentralized storage nodes are governed by a consensus protocol shared amongst the decentralized storage nodes;
record metadata including information about storage of the erasure-coded slivers on the decentralized storage nodes and a smart contract defining an access policy to access the erasure-coded slivers on a blockchain, wherein the smart contract prohibits, for a period, the re-writing of the BLOB or the erasure-coded slivers making up the BLOB for a period.

11. The computing system of claim 10, wherein the instructions further configure the computing system to:
periodically determine, by a verifier, whether the erasure-coded slivers are correctly stored;
when the erasure-coded slivers are correctly stored, record a cryptographic proof that the erasure-coded slivers are correctly stored;
when a first erasure-coded sliver at a first storage node of the erasure-coded slivers stored by the network of the decentralized storage nodes are not correctly stored, notify a data owner that the first erasure-coded sliver is not correctly stored;
reconstruct data to replace the first erasure-coded sliver using the erasure coding algorithm;
store the reconstructed data at a storage node different than the first storage node to maintain the integrity of the BLOB.

12. The computing system of claim 10, wherein the instructions further configure the computing system to:
receive a dummy BLOB to be stored with the BLOB, wherein the dummy BLOB is indistinguishable from the BLOB to a threat actor;
provide decryption keys for only the dummy BLOB to a verification entity; and
verify that the dummy BLOB is retrievable and decryptable as an indirect measure of overall data integrity.

13. The computing system of claim 11, wherein the cryptographic proofs are generated by:
using a cryptographic hash of the erasure-coded slivers;
compare the cryptographic hash to a reference value stored at the blockchain;
ensure that the erasure-coded slivers are valid without exposing decryption keys.

14. The computing system of claim 10, wherein the instructions further configure the computing system to:
receive a request to get or modify the BLOB;
access, from the blockchain, the metadata including information about storage of the erasure-coded slivers on the decentralized storage nodes and the smart contract defining the access policy;
request a portion of the erasure-coded slivers from a portion of the network of the decentralized storage nodes;
determine by the network of the decentralized storage nodes whether the request to get or modify the BLOB is permitted by the smart contract; and
fulfill the request to get or modify the BLOB when the request is permitted by the smart contract.

15. A non-transitory computer-readable storage medium comprising instructions stored thereon, the instructions cause at least one processor to:
divide a BLOB into a plurality of erasure-coded slivers;
erasure code the plurality of erasure-coded slivers using an erasure coding algorithm to yield erasure-coded slivers, the erasure-coded slivers make the BLOB resilient to data loss or corruption of some of the erasure-coded slivers;
store the erasure-coded slivers making up the BLOB across a network of decentralized storage nodes, wherein the decentralized storage nodes are governed by a consensus protocol shared amongst the decentralized storage nodes;
record metadata including information about storage of the erasure-coded slivers on the decentralized storage nodes and a smart contract defining an access policy to access the erasure-coded slivers on a blockchain, wherein the smart contract prohibits, for a period, the re-writing of the BLOB or the erasure-coded slivers making up the BLOB.

16. The non-transitory computer-readable storage medium of claim 15, wherein the metadata includes information verifying that the erasure-coded slivers are stored correctly, wherein the information verifying that the erasure-coded slivers are stored correctly includes cryptographic proofs that can be used to verify that the erasure-coded slivers are stored correctly by the decentralized storage nodes.

17. The non-transitory computer-readable storage medium of claim 16, wherein the cryptographic proofs are reported to the blockchain over a channel that is independent of the network of the decentralized storage nodes.

18. The non-transitory computer-readable storage medium of claim 15, wherein the instructions further cause at least one processor to:
periodically determine, by a verifier, whether the erasure-coded slivers are correctly stored;
when the erasure-coded slivers are correctly stored, record a cryptographic proof that the erasure-coded slivers are correctly stored;
when a first erasure-coded sliver at a first storage node of the erasure-coded slivers stored by the network of the decentralized storage nodes are not correctly stored, notify a data owner that the first erasure-coded sliver is not correctly stored;
reconstruct data to replace the first erasure-coded sliver using the erasure coding algorithm;
store the reconstructed data at a storage node different than the first storage node to maintain the integrity of the BLOB.

19. The non-transitory computer-readable storage medium of claim 18, wherein the cryptographic proofs are generated by:
using a cryptographic hash of the erasure-coded slivers;
compare the cryptographic hash to a reference value stored at the blockchain;
ensure that the erasure-coded slivers are valid without exposing decryption keys.

20. The non-transitory computer-readable storage medium of claim 15, wherein the instructions further cause at least one processor to:
receive a request to get or modify the BLOB;
access, from the blockchain, the metadata including information about storage of the erasure-coded slivers on the decentralized storage nodes and the smart contract defining the access policy;
request a portion of the erasure-coded slivers from a portion of the network of the decentralized storage nodes;
determine by the network of the decentralized storage nodes whether the request to get or modify the BLOB is permitted by the smart contract; and
fulfill the request to get or modify the BLOB when the request is permitted by the smart contract.
